(19) United States
(12) Patent Application Publication
(10) Pub. No.: US 2007/0024084 A1
(43) Pub. Date: Feb. 1, 2007

(54) Weather strip

(75) Inventors: Kisato Oba, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/493,913

(22) Filed: Jul. 27, 2006

(30) Foreign Application Priority Data
Jul. 28, 2005 (JP) P-2005-218616
Nov. 30, 2005 (JP) P-2005-346500

(51) Int. Cl. B60J 10/08

(52) U.S. Cl. 296/146.9; 49/475.1

(57) ABSTRACT

A weather strip has a mounting base portion which is mounted on a flange and a seal portion which is integrally provided on the mounting base portion, so as to seal a gap between a vehicle body opening open/close member and a vehicle body opening peripheral part. The mounting base portion is provided with at least an exterior side wall and a bottom wall, and a connecting portion between the exterior side wall and the bottom wall is formed more rigid than the other portions of the mounting base portion, a pressure sensitive adhesive double sided tape being bonded to an interior side surface of the exterior side wall. A flange contact portion which holds a distal end of the flange is formed on an inner surface of the bottom wall at a position in the vicinity of the connecting portion with the exterior side wall, while a caulking member which seals the distal end of the flange is mounted on the inner surface of the bottom wall except for the portion where the flange contact portion is formed.

### BACKGROUND OF THE INVENTION

1. Field of the Invention

The present invention relates to a weather strip in an automobile for sealing a gap between an open/close member for a vehicle body opening such as a door, a trunk lid and a sliding roof of a motor vehicle which opens and closes a vehicle body opening and a vehicle body opening peripheral part.

2. Related Art

Conventionally, as shown in FIG. 11, the sealing of a gap between an automotive door 2 and a vehicle body opening peripheral part 6 is effected by a door weather strip 160 which is mounted in a retainer 4 along an outer periphery of a door frame or the like of the door 2, a glass run 150 which is mounted within a channel 3 along an inner periphery of the door frame or the like and an opening trim weather strip 110 which is mounted on a flange 7 along the vehicle body opening peripheral part 6.

Note that the flange 7 is formed by joining together panels such as an outer panel 6a which defines the vehicle body opening peripheral part 6, an inner panel 8 which lies to the inside of a passenger compartment and the like.

The glass run 150 movably receives end portions of a door glass 5 in the door 2 in an interior of a main body thereof which is provided with an exterior side wall 151, a bottom wall 152 and an interior side wall 153 so as to form a substantially U-shaped cross section, and holds and seals the end portions of the door glass 5 with an exterior seal lip 154 and an interior seal lip 155 which are provided so as to extend from distal ends of the exterior side wall 151 and the interior side wall 153, respectively.

The door weather strip 160 mounted on the outer periphery of the door 2 is provided with a mounting base portion 161, a hollow seal portion 164 which is formed integrally on an upper portion of the mounting base portion 161 and a seal lip portion 166. The mounting base portion 161 is fitted in the retainer 4 provided along the outer periphery of the door frame so as to be fixed to the door frame. In addition, when the door 2 is closed, the seal lip portion 166 is brought into contact with a most exterior edge of the vehicle body opening peripheral part (the outer panel 6a) 6 so as to seal a gap between the door 2 and the exterior edge of the vehicle body opening peripheral part 6. As this occurs, the hollow seal portion 164 is brought into contact with a projecting portion of the vehicle body opening peripheral part 6 which lies closer to the inside of the passenger compartment than the portion of the peripheral part 6 with which the seal lip portion 166 is brought into contact so as to seal the gap between the door 2 and the vehicle body opening peripheral part 6.

The opening trim weather strip 110, which is mounted on the flange 7, resides along the vehicle body opening peripheral part 6 so as to seal the gap between the door 2 and the vehicle body opening peripheral part 6 at a portion which lies closer to the inside of the passenger compartment than the portion where the door weather strip 160 seals the vehicle body opening peripheral part 6. The opening trim weather strip 110 is mounted on the flange 7 by a trim portion 120 which functions as a mounting base portion having a substantially U-shaped cross section, so that a hollow seal portion 130 thereof is brought into contact with a projecting portion 2a of the door frame. A core material 124 such as a metallic insert is embedded in the trim portion 120 so as to grip on the flange 7, and flange holding lips are provided in an interior of the substantially U-shaped cross section of the trim portion 120.

However, in many cases, the opening trim weather strip 110 is mounted along the full periphery of the vehicle body opening peripheral part 6 which defines the opening in the vehicle body where the door 2 is placed to open and close the opening, and the flange 7 of the vehicle body opening peripheral part 6 varies in thickness depending on its locations. Namely, while the flange 7 is formed by joining together distal ends of panels which constitute the vehicle body, the number of panels which are joined together varies approximately from two to eight panels depending on the locations thereon, and the thickness thereof varies approximately in a range from 2 mm to 8 mm.

Due to this, when attempting to mount the trim portion 120 on the flange 7 which is formed to have a substantially U-shaped cross section with the core material 124 such as the metallic insert embedded therein to support the holding of the flange 7, there was a case where the flexibility of the trim portion 120 was lowered, whereby the inserting force was increased depending on locations or the gripping force on the flange 7 was decreased.

In addition, there has been a demand for elimination of the core material 124 such as the metallic insert in order to reduce the weight of a vehicle and facilitate the recycling of the vehicle.

To meet the demand, as shown in FIG. 12, the core material 124 such as the metallic insert is eliminated to increase the flexibility, and a pressure sensitive adhesive double sided tape 127 is used to mount an opening trim weather strip 110 to the flange 7 (for example, refer to JP-A-2002-127841). In this case, the pressure sensitive adhesive double sided tape 127 is mounted on an outer surface of an interior side wall 122 of a mounting base portion (a trim portion) 120 of the opening trim weather strip 110, and the interior side wall 122 is made to follow along the flange 7, so that the pressure sensitive adhesive double sided tape 127 is bonded to an exterior side surface of the flange 7 under pressure.

In addition, as shown in FIG. 13, when attempting to mount the flange 7 in the interior of the trim portion 120 provided with a bottom wall 123 and an exterior side wall 121 of the opening trim weather strip 110, the pressure sensitive adhesive double sided tape 127 is bonded to an interior side surface of the exterior side wall 121 so as to bond the opening trim weather strip 110 to a side of the flange 7 (for example, refer to JP-A-11-42984).

In this case, since the interior side surface of the exterior side wall 121 is made to be bonded to the side of the flange 7, even in the event that the thickness of the flange varies, the opening trim weather strip 110 can easily be mounted on the flange 7.

However, the flange 7 is formed by joining together distal ends of an outer panel 6a which defines the vehicle body opening peripheral part 6, an inner panel 8 which lies inside of the outer panel 6a and the like by welding or the like, and the outer panel 6a and the inner panel 8 form a cavity slightly inside of the flange 7. Noises such as wind noise, tire noise, road surface reflection noise are transmitted through the full periphery of the end portion of the flange 7, and gaps are produced in the flange 7 by irregularities resulting from spot welding and irregularities resulting from sheet metal working at the end portion of the flange 7, and the noises are allowed to leak out through the gaps to thereby be transmitted into the passenger compartment.

In addition, when mounting the opening trim weather strip 110 in a corner portion of the vehicle body opening peripheral part 6, since the metallic insert was eliminated, the rigidity of the trim portion 120 is lowered, and the exterior side wall 121 and the bottom wall 123 of the trim portion 120 collapse inward in the corner portion, thereby causing a problem that the position where the pressure sensitive adhesive double sided tape 127 is bonded varies or the pressure sensitive adhesive double sided tape 127 waves.

In order to prevent the noises leaking from the flange 7 and rainwater, dust and noise which intrude from the outside of the vehicle into the passenger compartment thereof by way of the interior of the trim portion 120 of the opening trim weather strip 110, there has been proposed a technique in which a non-drying sealer 170 having high viscosity is sealed in the interior of the trim portion 120, as shown in FIG. 14 (for example, refer to JP-UM-A-54-31622).

However, since this sealer 170 is a liquid having high viscosity, some labor hours are necessary to handle the sealer, and when attempting to remove the trim portion 120 from the flange 7 after the trim portion 120 has once been assembled to the flange 7 and remount the trim portion 120 on the flange 7, the sealer 170 bonds to the flange 7 and an outer surface of the trim portion 120, this making the remounting difficult.

Due to this, while there has been proposed a trial in which a caulking member is provided on an inner surface of the bottom wall 123 of the opening trim weather strip 110 shown in FIG. 13 for sealing, in the event that a distal end of the flange 7 is pressed against the caulking member, the rigidity of the bottom wall 123 is insufficient, and hence, the bottom wall 123 rotates downward as seen in FIG. 13, and this prevents the distal end of the flange 7 from being brought into sufficient contact with the caulking member, ending up with insufficient sealing properties.

Further, there exists a technique in which as shown in FIG. 15, in order to enhance the sealing properties of the opening trim weather strip 110 at a distal end of a flange 7, a reverse V-shaped lip 129 is formed on an inner surface of the bottom wall 123 of the trim portion 120 thereof so as to protrude into the interior of the trim portion 120, so that the distal end of the flange 7 is brought into contact with this reverse V-shaped lip 129 (for example, refer to JP-UM-A-55-9716).

In this case, only the reverse V-shaped lip 129 formed within the trim portion 120 is in contact with the distal end of the flange 7, and in the event that the distal end of the flange 7 deviates slightly, the distal end of the flange 7 moves apart from the reverse V-shaped lip 129, and hence, sufficient sealing properties could not be obtained.

In addition, there exists a technique in which as shown in FIG. 16, in order to enhance the sealing properties of the opening trim weather strip 110 at a distal end of the flange 7, a plurality of seal members 126 which are formed of a soft material such as a sponge material or the like are formed on an inner surface of the bottom wall 123 in the interior of the trim portion 120 thereof so as to encapsulate the distal end of the flange 7 by the plurality of seal members 126 (for example, refer to JP-UM-A-55-65209).

In this case, while the flexibility of the seal member 126 is larger than that of the one shown in FIG. 15, the distal end of the flange 7 needs to be positioned properly at the center of the seal members 126, and in addition, in the event that the thickness of the flange 7 varies, the seal members 126 cannot correspond to the variation in thickness so properly as to encapsulate the distal end of the flange 7 in a perfect fashion, and hence, sufficient sealing properties could not be obtained.

Furthermore, in the example of FIG. 14, labor hours are necessary to insert the sealer or seal member 170 which is formed separately into the interior of the trim portion 120 having the substantially U-shaped cross section. In addition, with the seal member 170 having viscosity used, when the trim portion 120 is removed from the flange 7 for repair, there may occur a case where the seal member 170 bonds to the flange 7 and the trim portion 120 to thereby damage the appearance of the vehicle. When the seal member 170 formed from the soft material such as the sponge material, similar to that shown in FIG. 16, with the thickness of the flange 7 varying, the seal member 170 cannot encapsulate the distal end of the flange 7 by varying according to the variation in the thickness of the flange 7, and hence, sufficient sealing properties could not be obtained.

In addition, in many cases, the opening trim weather strip 110 is mounted along the full periphery of the vehicle body opening peripheral part 6 which defines the opening in the vehicle body where the door 2 is placed to open and close the opening, and the flange 7 of the vehicle body opening peripheral part 6 varies in thickness depending on its locations. Namely, while the flange 7 is formed by joining together the distal ends of the panels which constitute the vehicle body, the number of panels which are joined together varies from one to on the order of five depending on the locations thereon, and the thickness thereof varies in the range from 2 mm to on the order of 8 mm.

Due to this, in the event that the trim portion 120 is formed to have a substantially U-shaped cross section with a metallic reinforcement insert as a core material 124 embedded therein to hold the flange 7 in the U-shaped cross section, there was a case where the inserting force varied largely or the gripping force applied on the flange 7 decreased.

In addition, the weight of the trim portion 120 is increased by virtue of the embedding of the metallic insert, and hence, the demand for a light-weight vehicle was not satisfied.

Due to this, there is proposed a technique, as shown in FIG. 17, in which the core material 124 such as the metallic insert is made unnecessary in a trim portion 120 so as to increase the flexibility of the trim portion 120, and then, the trim portion 120 is attached to the flange 7 using a pressure sensitive adhesive double sided tape 125 (for example, refer to JP-A-2001-151035).

In this case, in the trim portion 120 (the mounting base portion) 120 of an opening weather strip 110, the pressure sensitive adhesive double sided tape 125 is attached to an inner surface of an exterior side wall 122, and then, the flange 7 is inserted into the interior of the trim portion 120, while the pressure sensitive adhesive double sided tape 125 can be secured to an exterior side surface of the flange 7 under pressure.

When the opening trim weather strip 110 is bonded to the flange 7 by the pressure sensitive adhesive double sided tape 125, a protection tape on the pressure sensitive adhesive double sided tape 125 is peeled off, the flange 7 is inserted into the interior of the trim portion 120, and the pressure sensitive adhesive double sided tape 125 is secured to the side of the flange 7 under pressure. As this occurs, in particular, in the event that the trim portion 120 has a substantially U-shaped cross section, there sometimes occurred a case where the distal end of the flange 7 came into contact with the pressure sensitive adhesive double sided tape 125 to thereby peel off the same tape or the flange 7 was not inserted deep enough into the trim portion 120 to end up with being bonded to the pressure sensitive adhesive double sided tape on its way to the proper place in the trim portion 120.

In addition, in the event that the thickness of the flange 7 varies largely, there is adopted a technique in which the trim portion (a mounting base portion) 120 is provided with an exterior side wall 121 and the bottom wall 23 to be formed to have a substantially L-shaped cross section, not the substantially U-shaped cross section, to thereby omit the interior side wall so as to allow the flange 7 to freely project toward the inside of the passenger compartment.

In the event that the trim portion 120 is formed to have the substantially L-shaped cross section with the metallic insert deleted, however, the rigidity of the trim portion 120 is reduced, and hence, there was a risk that the bottom wall 123 deforms slightly, whereby the distal end of the flange 7 moves apart from the seal member 126 to thereby reduce the sealing properties. In particular, in the event that the end of the flange 7 which lies to the passenger compartment moves apart from the seal member 126, noises enter the interior of the passenger compartment from the distal end of the flange 7.

### SUMMARY OF THE INVENTION

In view of the above circumstances, an object of the invention is to provide a weather strip which can easily be mounted and ensure the prevention of intrusion of noise from the flange.

More specifically, an object of the invention is to provide a weather strip which can follow corners well and seal sufficiently so as to be mounted in a predetermined position assuredly and can prevent the intrusion of noise from the flange assuredly, without sealer.

With a view to solving the problem, according to the invention, there is provided a weather strip for sealing a gap between an open/close member of a vehicle body opening and a peripheral part of the vehicle body opening, the weather strip having:

a mounting base portion adapted to be mounted on a flange provided on one of the open/close member and the peripheral part of the vehicle body opening; and a seal portion provided integrally on the mounting base portion so as to be brought into contact with the other of the open/close member and the peripheral part of the vehicle body opening so as to seal the gap between the open/close member and the peripheral part of the vehicle body opening, wherein

the mounting base portion is provided with at least an exterior side wall and a bottom wall, a connecting portion of the exterior side wall with the bottom wall is formed more rigid than other portions of the mounting base portion and a pressure sensitive adhesive double sided tape is bonded to an interior side surface of the exterior side wall, and wherein

a flange contact portion for locking a distal end of the flange is formed on an inner surface of the bottom wall at a position lying in the vicinity of the connecting portion of the bottom wall with the exterior side wall, and a caulking member for sealing the distal end of the flange is mounted on the inner surface of the bottom wall except for the position where the flange contact portion is formed.

In this aspect of the invention, even in the event that a distal end of the flange is brought into contact with the bottom wall, the connecting portion between the exterior side wall and the bottom wall is made difficult to be deformed, and hence, there occurs no case where the bottom wall rotates about the connecting portion in a direction in which the bottom wall moves apart from the distal end of the flange.

In addition, since the pressure sensitive adhesive double sided tape is bonded to the interior side surface of the exterior side wall, by bonding the exterior side wall to the side of the flange by the pressure sensitive adhesive double sided tape, the pressure sensitive adhesive double sided tape follows the flange even in corner portions thereof so as to be kept bonded thereto assuredly, whereby even in the event that thickness of the flange varies, the opening trim weather strip can be mounted on the flange assuredly.

The flange contact portion for locking the distal end of the flange is formed on the inner surface of the bottom wall at the position lying in the vicinity of the connecting portion of the bottom wall with the exterior side wall. Due to this, the distal end of the flange is locked to the flange contact portion, so that the position where the weather strip is mounted on the flange can be determined assuredly, thereby making it possible to allow the pressure sensitive adhesive double sided tape to be bonded to a predetermined position on the exterior side wall assuredly. In addition, since the flange contact portion and the portion lying in the vicinity thereof are formed of a hard member, even in the event that the distal end of the flange is brought into contact therewith, the flange contact portion and its vicinity deform little, thereby making it possible to hold the flange in a predetermined position.

The caulking member for sealing the distal end of the flange is mounted on the inner surface of the bottom wall except for the position where the flange contact portion is formed. Due to this, the caulking member can cover the distal end of the flange so as to seal irregularities and gaps at the distal end of the flange, whereby not only noise can prevented from leaking through the irregularities and gaps to be transmitted into the passenger compartment but also rainwater and dust can be prevented from intruding into the passenger compartment.

According to the invention, the connecting portion between the exterior side wall and the bottom wall may be formed of a hard member.

In this aspect of the invention, the connecting portion is allowed to have a sufficient rigidity and can be extruded at the same time as the other portions of the mounting base portion, the manufacturing of the automotive weather strip being thereby facilitated.

According to the invention, the connecting portion between the exterior side wall and the bottom wall and the other portions of the bottom wall may be formed integrally of a hard member.

In the this aspect of the invention, the weather strip can be formed of the hard member continuously from the connecting portion to a distal end of the bottom wall, and even in the event that the distal end of the flange is brought into contact with the bottom wall, the bottom wall is made difficult to be deformed, thereby making it possible to secure the sealing properties with the distal end of the flange.

According to the invention, the hard member may be formed of a hard rubber of JIS HA85 to 95.

In this aspect of the invention, even in the event that the distal end of the flange is brought into contact with the bottom wall, the bottom wall has a sufficient hardness as to deform little.

According to the invention, an insert member may be embedded in the connecting portion between the exterior side wall and the bottom wall.

In this aspect of the invention, a sufficient rigidity can be given to the connecting portion, and the bottom wall is made difficult to be deformed, thereby making it possible to secure the sealing properties between the distal end of the flange and the bottom wall. The embedding of the insert can be implemented at the same time as extrusion of the weather strip, this facilitating the manufacturing of the automotive weather strip. Since the insert is embedded only in the connecting portion between the exterior side wall and the bottom wall, the insert can be made small in size, and there is little change of increasing the weight of the weather strip.

According to the invention, the caulking member may be formed so as to become thicker as it extends in a direction of the distal end of the bottom wall.

In this aspect of the invention, even in the event that the bottom wall rotates slightly downward about the connecting portion, there is no chance of the caulking member and the distal end of the flange being made to move apart from each other, thereby making it possible to enhance the sealing properties.

According to the invention, a cushion layer may be provided between the pressure sensitive adhesive double sided tape and the exterior side wall.

In this aspect of the invention, even in the event that there are irregularities on the surface of the exterior side wall, the pressure sensitive adhesive double sided tape can be bonded strongly to the exterior side wall, and even in the event that there are irregularities on the surface of the flange, both the flange and the pressure sensitive adhesive double sided tape can be bonded together.

According to the invention, the vehicle body opening open/close member may be a door, and the weather strip may be an opening trim weather strip.

In this aspect of the invention, since the vehicle body opening open/close member is the door and the weather strip is the opening trim weather strip, the gap between the vehicle body opening peripheral part and the door can be sealed assuredly, and the intrusion of noise intrude into the passenger compartment through gaps in the flange can be prevented by the mounting base portion assuredly.

Further, according to another aspect of the invention, there is provided a weather strip for sealing a gap between an open/close member of a vehicle body opening and a peripheral part of the vehicle body opening, the weather strip having:

a mounting base portion adapted to be mounted on a flange provided on one of the open/close member and the peripheral part of the vehicle body opening; and a seal portion provided integrally on the mounting base portion so as to be brought into contact with the other of the open/close member and the peripheral part of the vehicle body opening so as to seal the gap between the open/close member and the peripheral part of the vehicle body opening, wherein

the mounting base portion is provided with at least a bottom wall and an exterior side wall, and wherein

a pressure sensitive adhesive double sided tape is bonded to an interior side surface of the exterior side wall, a caulking member is provided on an inner surface of the bottom wall, an interior end portion of the bottom wall is formed more flexible than the other portions of the bottom wall, and an interior projecting portion is formed on an inner surface of the interior end portion of the bottom wall.

In this aspect of the invention, the weather strip has the mounting base portion adapted to be mounted on the flange provided on one of the open/close member and the peripheral part of the vehicle body opening and the seal portion provided integrally on the mounting base portion so as to be brought into contact with the open/close member or the peripheral part of the vehicle body opening so as to seal the gap between the open/close member and the peripheral part of the vehicle body opening. Due to this, when the open/close member is closed, the seal portion is brought into contact with either the peripheral part of the vehicle body opening or the open/close member to thereby seal the gap between the open/close member and the peripheral part of the vehicle body opening.

Since the mounting base portion is provided with at least a bottom wall and an exterior side wall, even in the event that the thickness of the flange varies, by causing the side of the flange to be firmly attached to the exterior side wall the distal end of the flange can securely be locked and sealed by the bottom wall. The exterior side wall can be positioned in a predetermined position by bringing the distal end of the flange into contact with the bottom wall.

In addition, since the pressure sensitive adhesive double sided tape is bonded to the interior side surface of the exterior side wall, the mounting base can be mounted on the flange irrespective of the thickness of the flange, and the area where the pressure sensitive adhesive double sided tape is bonded can be increased, whereby the mounting base portion can be bonded strongly and firmly.

Since the caulking member is provided on the inner surface of the bottom wall, the interior end portion of the bottom wall is formed more flexible than the other portions of the bottom wall and the interior projecting portion is formed on the inner surface of the interior end portion of the bottom wall, when the mounting base portion is mounted on the flange, the interior end portion of the bottom wall is allowed to bend in a direction of an end portion of the flange and an interior end portion of the caulking member is allowed to be secured to an interior end portion of the flange under pressure, whereby the sealing properties can be secured between the relevant portion of the weather strip and the interior end portion of the flange. Thus, the intrusion of noise from the distal end of the flange into the passenger compartment can be prevented.

According to the invention, the interior end portion of the bottom wall may be formed of a soft material within a range from ⅕ to ⅓ of the bottom wall from an interior end thereof, while the remaining portion of the bottom wall other than the interior end portion is formed of a hard material.

In this aspect of the invention, the interior end portion becomes rich in flexibility so as to easily bend in the direction of the end portion of the flange, thereby making it possible to secure the sealing properties between the interior end portion of the flange and the caulking member.

Since the remaining portion of the bottom wall other than the interior end portion is formed of the hard material, high rigidity can be provided, and there is little chance of the bottom wall rotating about the connecting portion between the exterior side wall and the bottom wall to thereby be deformed after the mounting base portion has been mounted on the flange, and hence, the distal end of the flange can be kept in contact with the caulking member, thereby making it possible to secure the sealing properties between the distal end of the flange and the caulking member of the bottom wall. In addition, since there is no need to use an insert member, the weight of the weather strip can be reduced. Additionally, the hard material stretches little, and when the weather strip is mounted on the flange, the weather strip stretches little relative to the flange, and therefore, there occurs no case where part of the weather strip rises from the flange or the weather strip is wrinkled.

According to the invention, an insert member may be embedded in an inner part of the exterior side wall and the remaining portion of the bottom wall other than the interior end portion.

In this aspect of the invention, the rigidity of the exterior side wall and the remaining portion of the bottom wall other than the interior end portion is increased, there is little chance of the relevant portions being deformed after mounted on the flange, and hence, there occurs no case where the bottom wall rotates about the connection portion thereof with the exterior side wall and being caused to deflect, thereby making it possible to secure the sealing properties between the distal end of the flange and the bottom wall. In addition, the insert member stretches little, and when the weather strip is mounted on the flange, the insert member stretches little relative to the flange, and therefore, there occurs no case where part of the weather strip rises from the flange or the weather strip is wrinkled.

According to the invention, an interior side surface of the caulking member and an exterior side surface of the interior projecting portion of the bottom wall may be secured to each other.

In this aspect of the invention, in the event that the distal end of the flange is brought into contact with the caulking member to thereby press against the caulking member, the distal end of the flange can pull inward both ends of the caulking member, whereby the caulking member pulls the interior projecting portion of the bottom wall toward the flange side, so that the distal end of the flange can be encapsulated. Thus, the intrusion of noise from the distal end of the flange into the passenger compartment can be prevented.

According to the invention, an outer surface of the interior end portion of the bottom wall may be brought into contact with an interior component provided on either of the open/close member and the peripheral part of the vehicle body opening, whereby the interior end portion of the bottom wall bends, and the interior projecting portion is made to incline in a direction of a side of the flange.

In this aspect of the invention, the outer surface of the interior end portion of the bottom wall is brought into contact with the interior component provided on either of the open/close member and the peripheral part of the vehicle body opening, whereby the interior end portion of the bottom wall bends, and the interior projecting portion is made to incline in the direction of the side of the flange. Due to this, a portion of the caulking member which is mounted on the interior end portion of the bottom wall can be made to securely encapsulate the distal end of the flange. Thus, the intrusion of noise from the distal end of the flange into the passenger compartment can be prevented.

According to the invention, a bottom wall lip may be formed on the outer surface of the interior end portion of the bottom wall, and the bottom wall lip so formed is brought into contact with an interior component provided on either of the open/close member and the peripheral part of the vehicle body opening, whereby the interior end portion of the bottom wall bends, and the interior projecting portion is made to incline in a direction of a side of the flange.

In this aspect of the invention, the bottom wall lip may be formed on the outer surface of the interior end portion of the bottom wall, and the bottom wall lip so formed may be brought into contact with the interior component provided on either of the open/close member and the peripheral part of the vehicle body opening, whereby the interior end portion of the bottom wall bends, and the interior projecting portion is made to incline in the direction of the side of the flange. Due to this, the bottom lip seals a gap between the interior member and the mounting base portion, and the bottom lip securely causes the interior end portion of the bottom wall to bend, whereby the portion of the caulking member which is mounted on the interior end portion of the bottom wall can be made to securely encapsulate the distal end of the flange. Thus, the intrusion of noise from the distal end of the flange into the passenger compartment can be prevented.

According to the invention, the interior projecting portion may be formed into a lip-like shape which tapers toward a distal end thereof for contact against the side of the flange.

In this aspect of the invention, the distal end of the flange can be encapsulated by a distal end of the lip-like shape of the interior projecting portion, whereby the lip-shaped interior projecting portion can prevent, together with the caulking member, the intrusion of noise from the distal end of the flange into the passenger compartment.

According to the invention, a stepped portion for locking a distal end of the flange may be formed on the inner surface of the bottom wall at a position in the vicinity of a connecting portion of the bottom wall with the exterior side wall.

In this aspect of the invention, the distal end of the flange is locked at the stepped portion, and the position where the weather strip is mounted on the flange can securely be determined. In addition, since the position of a distal end of an outer panel of the flange is determined by the stepped portion, the position where the mounting member of the weather strip is mounted on the flange is determined based on the distal end of the outer panel, and hence, there occurs no case where the mounting position varies.

According to the invention, the seal portion and the caulking member of the weather strip may be formed of a sponge material of an EPDM rubber or olefin-based thermoplastic elastomer, and the mounting base portion is formed of a solid material or finely foamed material of an EPDM rubber or olefin-based thermoplastic elastomer.

In this aspect of the invention, the seal portion and the caulking member of the weather strip may be formed of the sponge material of the EPDM rubber or olefin-based thermoplastic elastomer, and the mounting base portion may be formed of the solid material or finely foamed material of the EPDM rubber or olefin-based thermoplastic elastomer. Due to this, a simultaneous extrusion using the same type of material can be enabled so as to obtain a product having good weathering properties. In addition, since the same olefin-based resins and rubbers are used, the materials can be recycled without being sorted out, a product can be obtained which facilitates the recycling thereof.

In the invention, the distal end of the flange is locked to the flange contact portion, whereby the position where the weather strip is mounted on the flange can be determined assuredly. In addition, since the flange contact portion and its vicinity are formed of the hard member, there is little change of the flange contact portion and its vicinity being deformed, thereby making it possible to hold the flange in the predetermined position assuredly. The caulking member mounted on the inner surface of the bottom wall except for the position where the flange contact portion is formed can cover the distal end of the flange, so as to seal the irregularities and gaps at the distal end of the flange, whereby not only noise can be prevented from leaking through the irregularities and gaps to be transmitted into the passenger compartment but also rainwater and dust can be prevented from intruding into the passenger compartment.

In the invention, since the pressure sensitive adhesive double sided tape is bonded to the interior side surface of the exterior side wall, the mounting base portion can be mounted on the flange irrespective of the thickness of the flange, and the area where the pressure sensitive adhesive double sided tape is bonded can be increased, so that the mounting base portion can be bonded strongly and firmly.

Since the caulking member is mounted on the inner surface of the bottom wall, the interior end portion of the bottom wall is formed soft, and the interior projecting portion is formed on the inner surface of the interior end portion of the bottom wall, the interior end portion of the bottom wall can bend in the direction of the end portion of the flange, whereby the interior end portion of the caulking member can be secured to the interior end portion of the flange, so as to secure the sealing properties between the flange and the weather strip.

### BRIEF DESCRIPTION OF THE DRAWINGS

FIG. 1 is a cross sectional view taken along the line A-A in FIG. 5 which shows a state in which an opening trim weather strip according to a first embodiment of the invention is mounted on a vehicle body opening peripheral part;

FIG. 2 is a cross sectional view taken along the line A-A in FIG. 5 which shows a state in which an opening trim weather strip according to a second embodiment of the invention is mounted on the vehicle body opening peripheral part;

FIG. 3 is a cross sectional view taken along the line A-A in FIG. 5 which shows a state in which an opening trim weather strip according to a third embodiment of the invention is mounted on the vehicle body opening peripheral part;

FIG. 4 is a perspective view of a side of a motor vehicle;

FIG. 5 is a front view of the opening trim weather strip according to the embodiments of the invention;

FIG. 6 is a cross sectional view of an opening trim weather strip according to a fourth embodiment of the invention taken along the line A-A in FIG. 5 which shows a state in which the opening trim weather strip is mounted on a vehicle body opening peripheral part;

FIG. 7 is a cross sectional view, similar to FIG. 6, of an opening trim weather strip according to a fifth embodiment of the invention;

FIG. 8 is a cross sectional view, similar to FIG. 6, of an opening trim weather strip according to a sixth embodiment of the invention;

FIG. 9 is a cross sectional view, similar to FIG. 6, of an opening trim weather strip according to a seventh embodiment of the invention;

FIG. 10 is a cross sectional view, similar to FIG. 6, of an opening trim weather strip according to an eighth embodiment of the invention;

FIG. 11 is a cross sectional view showing a conventional seal construction between a door and a vehicle body opening peripheral part;

FIG. 12 is a cross sectional view showing a state in which another conventional door opening trim weather strip is mounted on the opening end of the motor vehicle.

FIG. 13 is a cross sectional view showing a state in which a further conventional door opening trim weather strip is mounted on the opening end of the motor vehicle;

FIG. 14 is a cross sectional view showing a state in which a further conventional door opening trim weather strip is mounted on the opening end of the motor vehicle;

FIG. 15 is a partial perspective view showing a further conventional opening trim weather strip;

FIG. 16 is a cross sectional view showing another conventional door opening trim weather strip which is mounted on an opening end of a motor vehicle; and

FIG. 17 is a cross sectional view showing another conventional door opening trim weather strip which is mounted on the opening end of the motor vehicle.

### DETAILED DESCRIPTION OF THE PREFERRED EMBODIMENTS

Embodiments of the invention will be described by taking an opening trim weather strip 10 as an example of the weather strip and a door 2 as an example of the vehicle body opening open/close member. In addition to the opening weather strip 10, the invention can be applied to a weather strip such as a sliding roof weather strip or a luggage compartment weather strip which is used on a vehicle body opening of a motor vehicle or an open/close member which covers the vehicle body opening to seal a gap between a vehicle body opening peripheral part and the open/close member when closed.

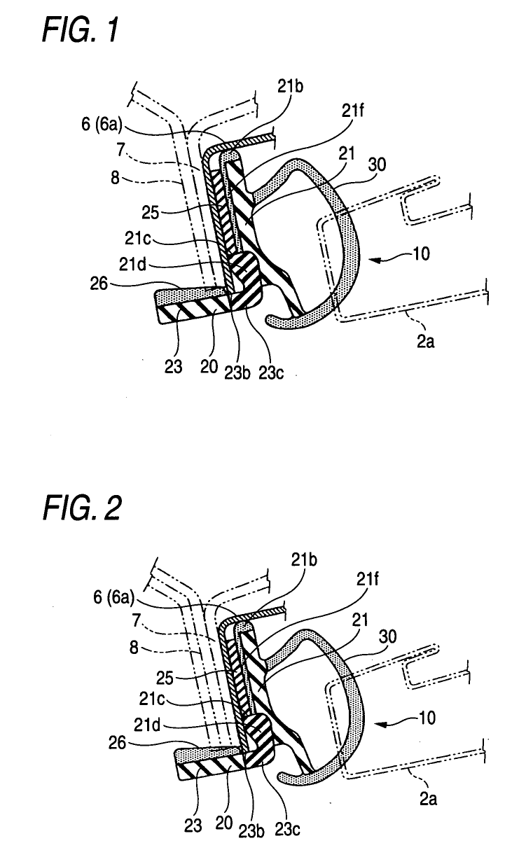

The invention will be described based on FIGS. 1 to 10.

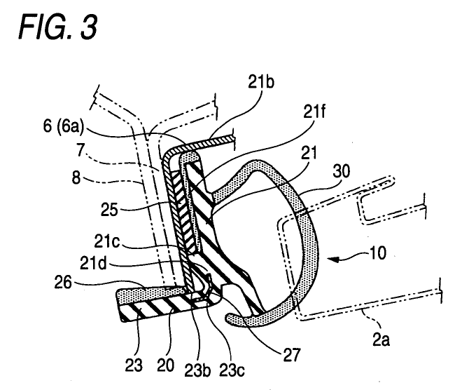

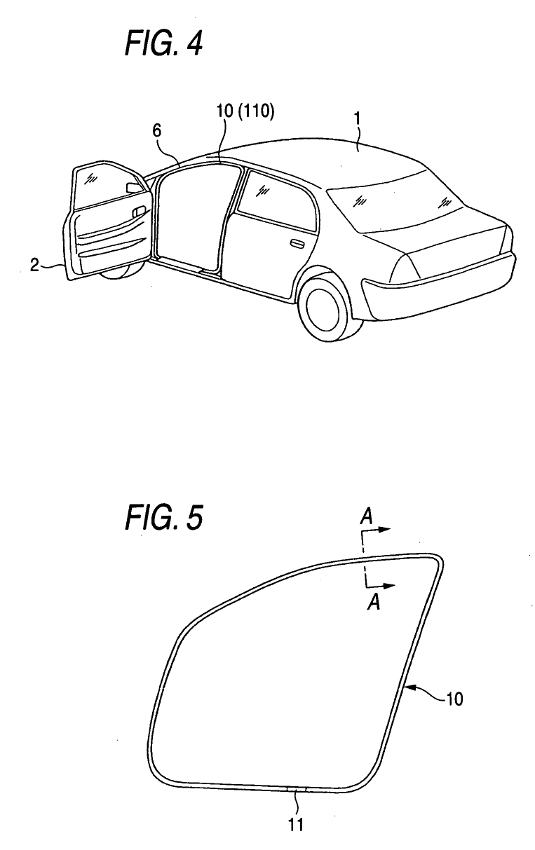

FIG. 1 is a cross sectional view taken along the line A-A in FIG. 5 which shows a state in which an opening trim weather strip 10 according to a first embodiment of the invention is mounted on a vehicle body opening peripheral part 6 shown in FIG. 4. FIG. 2 is a similar cross sectional view taken along the line A-A in FIG. 5 which shows a state in which an opening trim weather strip 10 according to a second embodiment of the invention is mounted on the vehicle body opening peripheral part 6 shown in FIG. 4. FIG. 3 is a similar cross sectional view taken along the line A-A in FIG. 5 which shows a state in which an opening trim weather strip 10 according to a third embodiment of the invention is mounted on the vehicle body opening peripheral part 6 shown in FIG. 4. FIG. 4 is a perspective view showing a state in which the opening trim weather strip 10 is mounted on the vehicle body opening peripheral part 6 in such a state that a door 2 of a motor vehicle is opened. FIG. 5 is an overall front view of the opening trim weather strip 10 that is to be mounted on the vehicle body peripheral part 6.

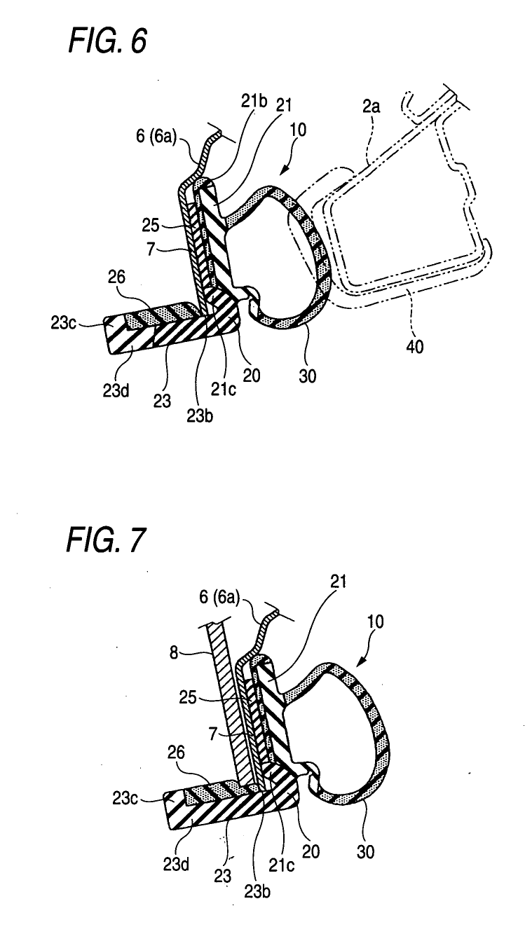

FIG. 6 is a cross sectional view of an opening trim weather strip 10 according to a fourth embodiment of the invention taken along the line A-A in FIG. 5 which shows a state in which the opening trim weather strip 10 is mounted on a vehicle body opening peripheral part 6 shown in FIG. 4. FIG. 7 is a similar cross sectional view to FIG. 6 which shows an opening trim weather strip 10 according to a fifth embodiment of the invention.

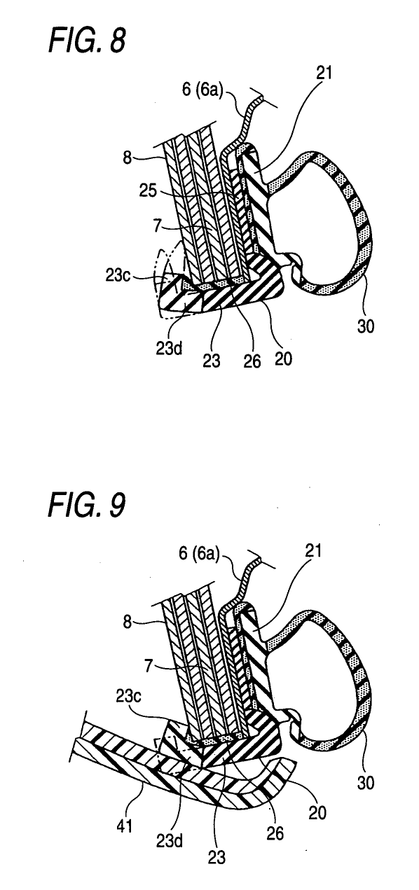

FIGS. 8 to 10 are similar cross sectional views to FIG. 6 which show opening trim weather strips 10 according to sixth to eighth embodiments of the invention.

FIG. 4 is a perspective view showing a state in which the opening trim weather strip 10 is mounted on the vehicle body opening peripheral part 6 in such a state that a door of a motor vehicle is opened. FIG. 5 is an overall front view of the opening trim weather strip 10 that is to be mounted on the vehicle body peripheral part 6.

As shown in FIG. 4, a vehicle body 1 of a motor vehicle has a vehicle body opening, and the vehicle body opening is opened and closed by a door 2 which is a vehicle body opening open/close member. A periphery of the vehicle body opening constitutes a vehicle body opening peripheral part 6, and the vehicle body opening peripheral part 6 forms a flange 7 (refer to FIGS. 1, 2) at a distal end thereof by welding together end portions of panel members such as an outer panel 6a, an inner panel 8 and the like which constitute the vehicle body. An opening trim weather strip 10 is mounted on the flange 7 which seals a gap between the vehicle body opening peripheral part 6 and the door 2.

On the flange 7, the number of panels which are welded together varies from 1 to on the order of 7 panels depending on locations on the vehicle body opening peripheral part 6 of the vehicle body 1.

The opening trim weather strip 10 is formed into a straight line through extrusion. A single opening trim weather strip 10 that is formed into the straight line is then mounted on the flange 7 along the shape of the vehicle body opening peripheral part 6 so as to become annular, as shown in FIG. 5. When mounted, the opening trim weather strip 10 is mounted on the flange 7 sequentially from one terminal end thereof, and when mounted completely, the other terminal end thereof comes to be joined to the one terminal end. The terminal ends may be molded together at a connecting portion 11 so as to form the opening trim weather strip 10 into the annular shape.

Alternatively, the terminal ends of the opening trim weather strip 10 may be bonded to each other with an adhesive before mounted on the flange 7 so as to form the opening trim weather strip 10 into the annular shape.

Forming the opening trim weather strip 10 into the annular shape facilitates the mounting thereof on the flange 7.

### First Embodiment

Next, based on FIG. 1, a cross sectional shape of the opening trim weather strip 10 according to the first embodiment of the invention will be described.

The opening trim weather strip 10 has a trim portion (a mounting base portion) 20 having a substantially L-shaped cross section which is to be mounted on the flange 7 and a hollow seal portion 30 which is formed integrally on the trim portion 20 so as to be brought into contact with a door frame projecting portion 2a of the door 2 so as to seal a gap between the door 2 and the vehicle body opening peripheral part 6.

The trim portion 20 is provided with an exterior side wall 21 and a bottom wall 23 and is bent integrally into an L-like shape. In order to flexibly follow a variation in thickness of the flange 7, the trim portion 20 is provided with the exterior side wall 21 and the bottom wall 23 and has no interior side wall which should otherwise be provided on an interior side thereof. However, a holding lip may be provided from a distal end of the bottom wall 23 for holding a side surface of the flange 7.

In addition, a wire which control longitudinal deformation or a narrow belt-like film can be embedded in the bottom wall 23.

The exterior side wall 21 is formed so as to have a substantially flat plate-shaped cross section, and a pressure sensitive adhesive double sided tape 25 is bonded to an interior side surface of the exterior side wall 21. The opening trim weather strip 10 is bonded to a side of the flange 7 by the pressure sensitive adhesive double sided tape 25.

When the pressure sensitive adhesive double sided tape 25 is used, since the opening trim weather strip 10 only has to be bonded to the exterior surface of the flange 7, even in the event that the thickness of the flange 7 varies, the same mounting method is adopted, the bonding force to the flange 7 remains the same, and the mounting is facilitated. In addition, when the pressure sensitive adhesive double sided tape 25 is bonded to the exterior side wall 21, an bonding area is increased, so as to allow the trim portion 20 to be bonded strongly and firmly.

In the event that the pressure sensitive adhesive double sided tape 25 is formed of a sponge material to thereby increase the thickness thereof and a bonding portion 21f of the exterior side wall 21 which lies on the side thereof where the pressure sensitive adhesive double sided tape 25 is bonded is formed of a sponge material, the pressure sensitive adhesive double sided tape 25 is closely bonded to the exterior side wall 21, and the exterior side wall 21 is allowed to deform so as to match irregularities such as spot marks or the like which are formed on the side surfaces of the flange 7, whereby the exterior side wall 21 can be brought into close contact with the flange 7.

A protruding portion 21c may be provided on an interior side surface of the exterior side wall 21 at a portion lying closer to the bottom wall 23. When an edge of the pressure sensitive adhesive double sided tape 25 is bonded along this protruding portion 21c, the positioning of the pressure sensitive adhesive double sided tape 25 can be implemented.

An exterior side wall connecting portion 21d and a bottom wall connecting portion 23c connecting portion where the exterior side wall 21 and the bottom wall 23 are connected integrally are formed of a hard material. In this case, the rigidity of the exterior side wall connecting portion 21d and the bottom wall connecting portion 23c is increased, whereby the bottom wall 23 can be prevented from rotating largely about the exterior side wall connecting portion 21d in a direction in which the bottom wall 23 moves apart from the distal end of the flange 7, that is, downward as seen in FIG. 1 even in the event that the bottom wall 23 is pressed against by the distal end of the flange 7 when the opening trim weather strip 10 is mounted on the flange 7.

In addition, even in the event that the opening trim weather strip 10 is mounted in a corner portion of the vehicle body opening peripheral part 6, neither the exterior side wall 21 nor the bottom wall 23 collapses inward, whereby the exterior side wall 21 can be bonded to a predetermined position on the flange 7.

A distal end portion 21b formed of a sponge material is formed integrally along a distal end of the exterior side wall 21. When the exterior side wall 21 is mounted on the flange 7, the distal end portion 21b is brought into contact with a bent portion of the outer panel 6a so as to seal a gap between the outer panel 6a and the opening trim weather strip 10.

The sponge material of the distal end portion 21b can be formed so as to extend from the distal end portion 21b to a boding portion 21f on the exterior side wall 21 where the pressure sensitive adhesive double sided tape 25 is bonded. In this case, as has been described above, not only the pressure sensitive adhesive double sided tape 25 and the exterior side wall 21 can be bonded firmly but also the irregularities such as spot marks formed on the side of the flange 7 can be absorbed further by the sponge material so extended.

The bottom wall 23 is formed substantially into a flat plate-like shape, and the bottom wall connecting portion 23c, which is the connecting portion with the exterior side wall 21 as is described above, is formed of the hard material, and the other portions of the bottom wall 23 except for the bottom wall connecting portion 23c is formed of a solid rubber.

A flange contact portion 23b is provided at a portion on an inner surface of the bottom wall connecting portion 23c where a distal end of the outer panel 6a of the flange 7 is brought into contact. A caulking sponge 26, which is a caulking member, which will be described later, is not provided in this portion, whereby the distal end of the outer panel 6a is brought into direct contact with the bottom wall 23 so that the distal end of the outer panel 6a is locked thereat.

By adopting this configuration, the position where the opening trim weather strip 10 is mounted on the flange 7 can be determined assuredly.

As has been described above, since the bottom wall connecting portion 23c and the exterior side wall connecting portion 21d are formed of the material which is harder than the other portions of the bottom wall 23 and the exterior side wall 21 (the hard member), even in the event that the bottom wall connecting portion 23c and the exterior side wall connecting portion 21d are pressed against by the distal end of the flange 7 when the distal end of the flange 7 is brought into contact therewith, there is little chance of the bottom wall 23 being deformed, whereby the position where the exterior side wall 21 is bonded to the flange 7 can be determined, thereby making it possible to hold the flange 7 assuredly.

The hard material of the bottom wall 23 can be formed of a hard rubber of JIS HA85 to 95, for example. Due to this, even in the event that the distal end of the flange 7 is brought into contact with the flange contact portion 23b, the bottom wall 23 has a sufficient hardness, and hence, there is little change of the bottom wall 23 being deformed.

The other portions of the bottom wall 23 and the exterior side wall 21 can be formed of a soft solid rubber of JIS HA60 to 80. Due to this, the relevant portions can have both such a sufficient strength as to hold the distal end of the flange 7 and such a sufficient flexibility as to follow a variation in thickness of the flange when the variation occurs due to an increase in the number of panels which constitute the flange.

The caulking sponge 26, which is a caulking member of a sponge, is provided on the inner surface of the bottom wall 23. While any other materials than the sponge material can be used as the caulking member, provided that those materials have enough flexibility to encapsulate and seat the distal end of the flange 7, the sponge member is rich in flexibility and hence is preferable for use. The caulking member can also be formed into a hollow shape of a soft rubber. The caulking sponge 26 is provided from the distal end of the bottom wall 23 just before the flange contact portion 23b and is formed so as to ensure that the distal end of the inner panel 8 of the flange 7 can be brought into contact with the caulking sponge 26.

The caulking sponge 26 is formed into a substantially trapezoidal shape in cross section in which it becomes taller along the distal end of the bottom wall 23 and shorter along the bottom wall connecting portion 23c side.

Due to this, even in the event that the bottom wall 23 is pressed against by the distal end of the flange 7 after the trim portion 20 has been mounted on the flange 7 and is then caused to rotate about the connecting portion with the exterior side wall 21 in the direction in which the bottom wall 23 moves apart from the distal end of the flange 7 (downward) to thereby deform, the caulking sponge 26 is formed so as to be taller at an interior end portion thereof, and hence, there is no chance of the caulking sponge 26 moving apart from the distal end of the flange 7, whereby there is no chance of noise and rainwater leaking from the distal end of the flange, thereby making it possible to secure the sealing properties.

In addition, in the flange 7, normally, the outer panel 6a which lies outermost is formed longest at the distal end thereof among the panels making up the flange 7, and the inner panel 8 is formed shorter than the outer panel 6a at the distal end thereof. Since the plurality of panels are welded together in the flange 7, there occurs a case where the distal end of the outer panel 6a does not coincide with those of the other panels and hence the dimensions of the panels at the distal ends thereof vary. However, since the caulking sponge 26 is formed into the trapezoidal shape in which it becomes tall along the distal end thereof, the caulking sponge 26 can absorb the variation to thereby encapsulate the distal end of the flange 7.

The hollow seal portion 30 is provided integrally on an outer surface of the exterior side wall 21. The hollow seal portion 30 is formed of a hollow sponge material having a substantially oval cross section on the outer surface of the exterior side wall 21. A sponge rubber, sponge thermoplastic elastomer or the like is used for the sponge material. The hollow seal portion 30 is, when the door is closed, for example, brought into contact with the door frame projecting portion 2a of the door frame of the door 2 so as to seal a gap between the door 2 and the vehicle body opening peripheral part 6. The hollow seal portion 30 can be formed from the bottom wall 23 depending on the position of a mating member with which it is brought into contact.

In place of the hollow seal portion 30, a lip-shaped seal portion, which is not hollow, may be provided on the outer surface of the exterior side wall 21.

In the opening trim weather strip 10, when the hollow seal portion 30 and the caulking sponge 26 are formed of the sponge material of EPDM rubber or olefin-based thermoplastic elastomer, the portions of the trim portion 20 other than the portion which is made of the hard material are formed of a solid material or finely foamed material of EPDM rubber or olefin-based thermoplastic elastomer, and the portion of the trim portion 20 which is formed of the hard material is formed of a solid material of EPDM rubber or olefin-based thermoplastic elastomer, a product can be obtained which has good weathering properties. In addition, in this case, the opening trim weather strip 10 is olefin based as a whole, and hence, it can be ground altogether to be recycled for reuse.

### Second Embodiment

Next, a second embodiment of the invention will be described based on FIG. 2. The second embodiment differs from the first embodiment in that a bottom wall 23 is different from that of the first embodiment with the other constituent portions remaining the same as those of the first embodiment, and therefore, only the different portion will be described and the description of the same portions will be omitted.

A bottom wall 23 is formed into a substantially flat plate-like shape and is formed of a hard material as a whole including a bottom wall connecting portion 23c which is a continuous portion to an exterior side wall 21. Due to this, the bottom wall 23 can be formed of a hard member integrally from the bottom wall connecting portion 23c to a distal end of the bottom wall 23, whereby even in the event that a distal end of a flange 7 is brought into contact with the bottom wall 23 and a caulking sponge 26, the bottom wall 23 is made difficult to be deformed, thereby making it possible to secure the sealing properties between the distal end of the flange 7 and the bottom wall 23. In addition, since the exterior side wall 21 is made of a flexible solid rubber or the like, even in the event that a trim portion 20 is mounted in a corner portion of a vehicle body opening peripheral part 6, the trim portion 20 can follow the corner portion, whereby the exterior side wall 21 can be bonded to a side of the flange 7.

### Third Embodiment

Next, a third embodiment of the invention will be described based on FIG. 3. The third embodiment differs from the first embodiment in that an insert member 27 is embedded in a bottom wall connecting portion 23c and an exterior side wall connecting portion 21d with the other constituent portions remaining the same as those of the first embodiment, and therefore, only the different portion will be described and the description of the same portions will be omitted.

As shown in FIG. 3, the insert member 27 is embedded in a bent continuous portion which stretches between an exterior side wall 21 and a bottom wall 23, that is, in the exterior side wall connecting portion 21d and the bottom wall connecting portion 23c so as to be bent at substantially right angles as seen in cross section to follow a bent angle.

Due to this, a sufficient rigidity can be given to a connecting portion between the exterior side wall connecting portion 21d and the bottom wall connecting portion 23c, whereby even in the event that a flange 7 pushes down the bottom wall 23 and a caulking sponge 26, the sealing properties between a distal end of the flange 7 and the bottom wall 23 can be secured. In addition, the embedding of the insert member 27 can be implemented by pushing out the insert member 27 at the same time that an opening trim weather strip 10 is extruded, and this facilitates the manufacturing of the opening trim weather strip 10. Since the insert member 27 is embedded only in the connecting portion of the exterior side wall 21 and the bottom wall 23, the insert member 27 can be narrowed in width, and hence, there is little chance of the weight of the opening trim weather strip 10 being increased.

Next, a manufacturing method of the opening trim weather strip 10 according to the first to third embodiment will be described.

This opening trim weather strip 10 is made through extrusion, and a solid rubber making up a trim portion 20 and a sponge rubber making up a hollow seal portion 30 can be extruded integrally by an extruding machine.

Thereafter, the opening trim weather strip 10 so extruded is vulcanized and cut by the normal methods.

### Fourth Embodiment

Next, based on FIG. 6, the opening trim weather strip 10 according to the fourth embodiment of the invention will be described.

The opening trim weather strip 10 has a trim portion 20 as a mounting base portion having a substantially L-shaped cross section which is to be mounted on the flange 7 and a hollow seal portion 30 as a hollow seal portion which is formed integrally on the trim portion 20 so as to be brought into contact with a door frame projecting portion 2a of the door 2 so as to seal a gap between the door 2 and the vehicle body opening peripheral part 6.

The trim portion 20 is formed so as to have a substantially L-shaped cross section which is provided with an exterior side wall 21 and a bottom wall 23. In order for the trim portion 20 to be enabled to correspond flexibly to a variation in thickness of the flange 7, the bottom wall 23 has a predetermined width. The exterior side wall 21 and the bottom wall 23 of the trim portion 20 are formed integrally and continuously, and no insert (core material) is embedded therein which is formed of a metallic plate or a hard synthetic resin so as to reinforce the holding force with which the flange 7 is held. This enables the reduction in weight of the opening trim weather strip 10.

The bottom wall 23 is formed substantially into a flat plate-like shape and is formed of a hard material continuously and integrally from the exterior side wall 21 to a portion lying slightly closer to an edge or interior side of the bottom wall 23 than a central portion thereof. An interior end portion 23d, which is formed of a soft material, is formed from the portion lying slightly closer to the distal end portion than the central portion to the distal end of the bottom wall 23, and an interior projecting portion 23c, which is formed similarly of a soft material, is formed on an inner surface or upper surface as viewed in FIG. 6 of the interior end portion 23d so as to extend upward from a distal end of the interior end portion 23d.

Note that the interior end portion 23d of the bottom wall 23 is formed, in terms of a widthwise dimension of the bottom wall 23, to extend within a range of ⅕ to ⅓ of the bottom wall 23 from the interior end thereof, and in this embodiment, the interior end portion 23d is formed to such a widthwise dimension as to extend to about ⅓ of the bottom wall 23. In case the interior end portion 23d is formed shorter than ⅕ of the width of the bottom wall 23, the rotation of the interior end portion 23, which is caused when pulled by the caulking sponge 26 at the distal end of the flange 7, becomes difficult to occur, whereas in case the interior end portion 23d is formed longer than ⅓, a rotational fulcrum of the interior end portion 23d is supported by the distal end of the thick flange 7, whereby the rotation of the interior end portion 23d is also made difficult to occur.

Since it is formed of the soft material, the interior end portion 23d of the bottom wall 23 is rich in flexibility, and as will be described later on, the interior end portion 23d bends easily when brought into contact with a garnish 40 which is an interior component of the vehicle body or when pulled by the caulking sponge 26 as the caulking member, whereby the interior projecting portion 23c can easily bend in a direction of a side end portion of the flange 7, so that an interior end portion of the caulking sponge 26 can cover an interior side end of the flange 7, thereby making it possible to secure the sealing properties between the interior side end portion of the flange 7 and the caulking sponge 26.

Since the remaining portion of the bottom wall 23 other than the interior end portion 23d thereof is made of the hard material, the rigidity of the relevant portion becomes high, and even in the event that a distal end of an outer panel 2d of the flange is brought into contact with the bottom wall 23 to thereby push on the bottom wall 23 when the trim portion 20 is mounted on the flange 7, there is little chance of the portion of the bottom wall 23 which is formed of the hard material being deformed, and hence, there is little chance of the bottom wall 23 rotating about the connecting portion between the exterior side wall 21 and the bottom wall 23 to thereby be deformed, whereby the position where the exterior side wall 21 is mounted on the flange 7 can be determined, so as not only to securely hold the flange 7 but also to allow the distal end of the flange 7 to be kept in contact with the caulking sponge 26, thereby making it possible to secure the sealing properties between the distal end of the flange 7 and the caulking sponge 26 of the bottom wall 23.

A hard rubber or a hard synthetic resin can be used as the hard material, and as the hard rubber, a hard EPDM rubber of JIS HA85 to 95 can be used, while as the hard synthetic resin, a hard polyethylene, polypropylene or the like can be used. Furthermore, a hard olefin-based thermoplastic elastomer of JIS HA85 to 95 can also be used. Since the materials having the aforesaid hardnesses are used as the hard material, the deformation of the trim portion 20 can be prevented with no insert.

In addition, these hard materials deform little, and when the opening trim weather strip 10 is mounted on the flange 7, the hard materials stretch little relative to the flange 7, whereby there occurs no case where part of the opening trim weather strip 10 is caused to float from the flange 7 or the opening trim weather strip 10 is creased.

When extruding the opening trim weather strip 10, in a case where the hard EPDM rubber, the hard material is formed using the hard polyethylene, polypropylene or the like is used as the hard material and the other portions formed using a soft EPDM rubber or olefin-based thermoplastic elastomer, the hard and soft materials can be extruded simultaneously using an extruding machine.

The portions of the trim portion 20 other than the portions formed of the hard material and the sponge material (including the interior end portion 23d of the bottom wall 23, the interior projecting portion 23c) can be formed of a soft EPDM rubber or olefin-based thermoplastic elastomer of JIS HA60 to 85. Due to this, a sufficient strength to hold the flange 7 and a sufficient flexibility to follow a change in shape of the flange 7 can be provided together.

A stepped portion 23b is formed on an inner surface of the bottom wall 23 at a position in the vicinity of the connecting portion thereof with the exterior side wall 21 so that the distal end of the flange 7 is brought into locked engagement therewith. The stepped portion 23b may be, as shown in FIG. 7, formed into a step-like shape having an L-shaped cross section on the bottom wall 23, or as shown in FIG. 6, the stepped portion 23 may be formed by a side of a caulking sponge 26 and the inner surface of the bottom wall 23.

The distal end of the flange 7 or the distal end of the outer panel 6a in this embodiment is brought into contact with a portion on a bottom of the stepped portion 23b and a side of a distal end portion of the outer panel 6a is brought into contact with a portion on a side of the stepped portion 23b, that is, a side of the caulking sponge 26, whereby the distal end of the outer panel 6a is locked, and the position where the opening trim weather strip 10 is mounted on the flange 7 can be securely determined.

In a case where the bottom wall 23 including the stepped portion 23b is formed of the hard rubber, even in the event that the distal end of the outer panel 6a is brought into contact with the stepped portion 23b, since the stepped portion 23 has the sufficient hardness, the stepped portion 23 deforms little.

The caulking sponge 26 which is a caulking member is provided on the inner surface of the bottom wall 23. Other materials than the sponge material may be used as the caulking member as long as the materials are such as to encapsulate and seal the distal end of the flange 7. The caulking sponge 26 is provided from an interior end portion 26b of the bottom wall 23 to the vicinity of the stepped portion 23b and is formed in such a manner that the distal end of the outer panel 6a, which constitutes the longest end of the flange 7, can be brought into contact with the stepped portion 23b.

The caulking sponge 26 is formed into a flat plate-like shape on the inner surface or upper surface as viewed in FIG. 6. Due to this, in the event that the flange 7 is provided with the inner panel 8 and other panels, distal ends of those panels are embedded in a surface of the caulking sponge 26 after the trim portion 20 has been mounted on the flange 7, and the distal end of the flange 7 is never separated from the caulking sponge 26, thereby making it possible to secure the sealing properties thereat.

The hollow seal portion 30, which functions as a seal portion, is provided integrally on an outer surface of the exterior side wall. The hollow seal portion 30 is formed of a hollow sponge material having a substantially oval cross section on the outer surface of the exterior side wall 21. A sponge rubber, sponge thermoplastic elastomer or the like is used for the sponge material. The hollow seal portion 30 is, when the door is closed, for example, brought into contact with the projecting portion 2a of the door frame so as to seal a gap between the door 2 and the vehicle body opening peripheral part 6. A garnish 40 may be attached to the projecting portion 2a of the door frame of the door 2 in order to enhance the appearance of the vehicle, and as this occurs, the hollow seal portion 30 is then brought into contact with the garnish 40 so attached. The hollow seal portion 30 can be formed on an outer surface of the bottom wall 23 depending on the position of a mating member with which the hollow seal portion 30 is brought into contact.

In place of the hollow seal portion 30, a lip-shaped seal portion, which is not hollow, may be provided on the outer surface of the exterior side wall 21 as the seal portion.

When the opening trim weather strip 10 of the fourth embodiment is mounted on the flange 7, firstly, the trim portion 20 of the opening trim weather strip 10 is positioned obliquely relative to the flange 7, so that the distal end of the outer panel 6a of the flange is brought into contact with the bottom wall 23. As this occurs, since no interior side wall 22 exists on the trim portion 20, the flange 7 can be inserted while being caused to fall obliquely relative to the trim portion 20.

As this occurs, since the outer panel 6a which lies laterally most outward among the panels making up the flange 7 is made slightly longer than the other panels, the distal end thereof comes into contact with the stepped portion 23b of the bottom wall 23. As this occurs, a side of the outer panel 6a is brought into contact with the protruding portion 21c of the exterior side wall 21, and the pressure sensitive adhesive double sided tape 25 is bonded to the side of the outer panel 6a.

### Fifth Embodiment

Next, a fifth embodiment of the invention will be described with respect to a cross sectional shape of an opening weather strip 10 based on FIG. 7. The fifth embodiment differs from the fourth embodiment in that a flange 7 is provided with two panels; an outer panel 6a and an inner panel 8, and that a stepped portion 23b of a bottom wall 23 is formed into a step-like shape, and the different features will be described mainly, the description of like constituent portions to those of the fourth embodiment being omitted.

As shown in FIG. 7, since the stepped portion 23b of the bottom wall 23 is formed into the step-like shape, a distal end of the outer panel 6a is brought into engagement with the stepped portion 23b, and since a side of the outer panel 6a is brought into contact with a protruding portion 21c of an exterior side wall 21, the positioning of a pressure sensitive adhesive double sided tape 25 that is to be bonded to a side of the flange 7 can be enabled.

In addition, a distal end of the inner panel 8 is brought into contact with a caulking sponge 26, so that a gap between the outer panel 6a and the inner panel 8 can be covered by an interior end portion of the caulking sponge 26 to thereby prevent the intrusion of noise or the like into the passenger compartment, thereby making it possible to secure the sealing properties thereat.

### Sixth Embodiment

Next, a sixth embodiment will be described based on FIG. 8 with respect to a cross sectional shape of an opening trim weather strip 10. The sixth embodiment differs from the fourth embodiment in that a flange 7 is provided with an outer panel 6a, an inner panel 8 and a plurality (three) of additional panels and that a distal end of an interior projecting portion 23c of a bottom wall 23 is formed into a lip-like shape, and the different features will be described mainly, the description of similar constituent portions to those of the fourth embodiment being omitted.

In the event that the distal end of the interior projecting portion 23c of the bottom wall 23 is formed into the lip-like shape, with the number of panels making up the flange 7 being large, as shown in FIG. 8, when a distal end of the flange 7 is brought into contact with a caulking sponge 26, an interior side end portion of the caulking sponge 26 is pulled by the flange 7. As this occurs, since an interior side surface of the caulking sponge 26 and an interior side surface of the interior projecting portion 23c are secured to each other by bonding or welding, in the event that the distal end of the flange 7 is brought into contact with the caulking sponge 26 to thereby press against the caulking sponge 26, the caulking sponge 26 can pull the interior projecting portion 23c of the bottom wall 23 to the flange 7 side, so that the caulking sponge 26 can be made to encapsulate the distal end (in particular, an interior side end portion) of the flange. Thus, the intrusion of noise from the distal end of the flange 7 into the passenger compartment can be prevented.

Furthermore, since a lip-shaped distal end of the interior projecting portion 23c of the bottom wall 23 is brought into contact with a side of the flange 7, the distal end of the flange 7 can be encapsulated by the lip-shaped distal end of the interior projecting portion 23c, whereby the interior projecting portion 23c can prevent, together with the caulking sponge 26, the intrusion of noise from the distal end of the flange 7 into the passenger compartment.

### Seventh Embodiment

Next, a seventh embodiment will be described based on FIG. 9 with respect to a cross sectional shape of an opening trim weather strip 10. The seventh embodiment differs from the fourth embodiment in that a garnish 41 is brought into contact with a bottom wall interior end portion 23d of a bottom wall 23, and the different feature will be described mainly, the description of similar constituent portions to those of the fourth embodiment being omitted.

Since the interior end portion 23d of the bottom wall 23 has flexibility, when the interior end portion 23 is brought into contact with the garnish 41, which is an interior component mounted on the vehicle body or the like, an outer surface of the interior end portion 23d bends upward as viewed in FIG. 9, whereby an interior projecting portion 23c is caused to incline in a direction of a side of the flange, and a portion of a caulking sponge 26 which is mounted on the interior end portion 23d can be made to securely encapsulate a distal end of the flange 7. Thus, the intrusion of noise from the distal end of the flange 7 into the passenger compartment can be prevented. In addition, a distal end of the interior projecting portion 23c can be brought into contact with the side of the flange 7, and as this occurs, the distal end of the flange 7 can be sealed more securely.

### Eighth Embodiment

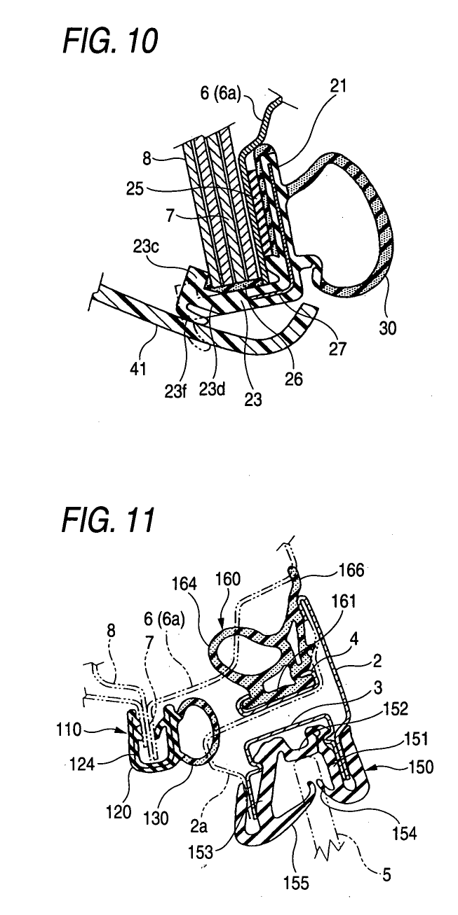

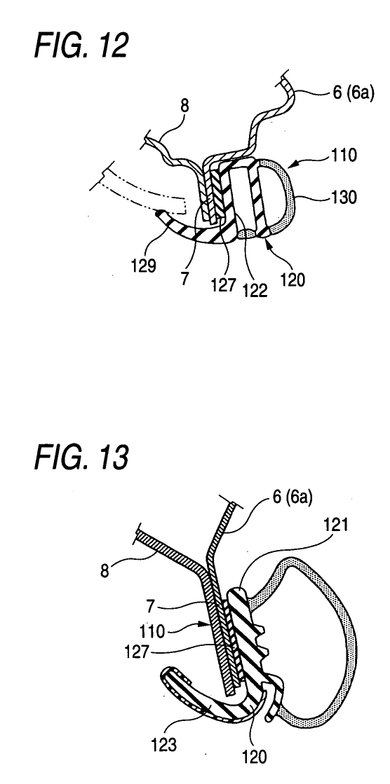

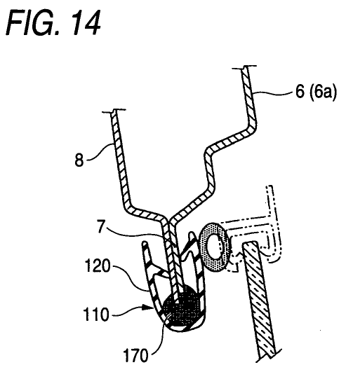

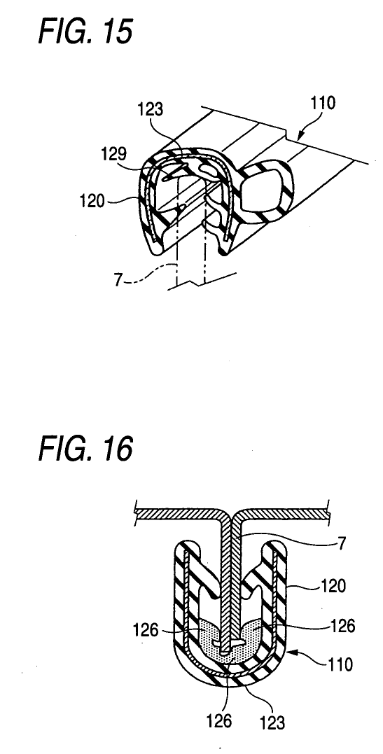

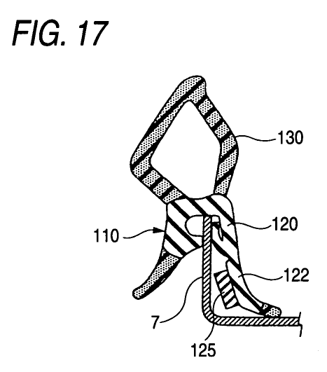

Next, an eighth embodiment will be described based on FIG. 10 with respect to a cross sectional shape of an opening trim weather strip 10. The eighth embodiment differs from the fourth embodiment in that a bottom wall lip 23f is formed on an outer surface of an interior projecting portion 23d, that an insert member 27 is embedded in a trim portion 20 and that an exterior side wall 21 and the whole of a bottom wall 23 are formed of the same material, and the different features will be described mainly, the description of similar constituent portions to those of the fourth embodiment being omitted.

A bottom wall lip 23f is formed so as to incline externally on the outer or lower surface as viewed in FIG. 10 of the interior end portion 23d of the bottom wall 23. Due to this, when the opening trim weather strip 10 is mounted on a flange 7, as with the seventh embodiment that has just been described above, the bottom wall lip 23f is brought into contact with a back side of a garnish 41, which is an interior component mounted on the vehicle body or the like, and since the insert member 27 is not embedded in the bottom wall interior end portion 23d, the interior end portion 23d bends, whereby the interior end portion 23d is allowed to incline in a direction of a side of the flange 7. Thus, the bottom wall lip 23f seals a gap between the garnish 41 and the trim portion 20, while the bottom wall lip 23f causes securely the interior end portion 23 to bend, whereby a portion of a caulking sponge 26 which is mounted on the interior end portion of the bottom wall 23 can be made to encapsulate a distal end of the flange 7. Thus, the intrusion of noise from the distal end of the flange 7 into the passenger compartment can be prevented.

In addition, the insert member 27 can be embedded in portions other than the exterior side wall 21 and the interior end portion 23d of the bottom wall 23. In this case, the rigidity of the remaining portion other than the exterior side wall 21 and the interior end portion 23d of the bottom wall 23 is increased, and hence, there is little chance of the remaining portion other than the exterior side wall 21 and the interior end portion 23d of the bottom wall 23 being deformed after the trim portion 20 is mounted on the flange 7. In addition, there occurs no case where the bottom wall 23 rotates about a connecting portion between the exterior side wall 21 and the bottom wall 23 to thereby be deflected, thereby making it possible to secure the sealing properties between the distal end of the flange 7 and the caulking sponge 26 of the bottom wall 23. In addition, since not a hard material but a normal solid material can be used for the exterior side wall 21 and the bottom wall 23, the extrusion of the opening trim weather strip 10 can be facilitated irrespective of types of materials.

In addition, since the insert member 27 is not embedded in the bottom wall interior end portion 23d, the interior end portion 23d can have flexibility.

Furthermore, the insert member 27 stretches little, and when the opening trim weather strip 10 is mounted on the flange 7, the insert member 27 stretches little relative to the flange 7, and therefore, there is little chance of part of the opening trim weather strip 10 being caused to rise from the flange 7 of a vehicle body opening peripheral part 6 and wrinkled.

Additionally, in the event that the flange 7 is formed by welding together the outer panel 6a, the inner panel 8 and additional several panels, as shown in FIG. 10, a distal end of the outer panel 6a is brought into contact with a stepped portion 23b of the bottom wall 23, and distal ends of the inner panel 8 and additional several panels with the caulking sponge 26. Thus, even in case gaps resulting from marks of spot welding exist between the outer panel 6a, inner panel 8 and additional several panels, the interior projecting portion 23c can cover the gaps so as to secure the sealing properties.

In the opening trim weather strips 10 according to the fourth to eighth embodiments of the invention, when the hollow seal portion 30 is formed of the sponge material of EPDM rubber or olefin-based thermoplastic elastomer, the remaining portion of the trim portion 20 other than the portion which is made of the hard material is formed of the solid material or finely foamed material of EPDM rubber or olefin-based thermoplastic elastomer, and the portion of the trim portion 20 which is formed of the hard material is formed of the solid material of EPDM rubber or olefin-based thermoplastic elastomer, a product can be obtained which has good weathering properties. In addition, in this case, the opening trim weather strip 10 is olefin based as a whole, and hence, it can be ground altogether to be recycled for reuse.

Note that while in the embodiments that have been described heretofore, the caulking sponge 26 is described as being formed into the flat plate-like shape, the caulking sponge 26 may have a hollow space in the interior thereof and be formed into a bridge-like shape having a substantially L-shaped cross section which is connected to an exterior side surface of the interior projecting portion 23c along one end and to the inner surface of the bottom wall 23 along the other end thereof. In this case, too, the same function and advantage as those of the fourth embodiment.

Next, a manufacturing method of the door opening trim weather strip 10 according to the fourth to eighth embodiments will be described.

This door opening trim weather strip 10 is made through extrusion, and the solid rubber making up the trim portion 20 and the sponge rubber making up the hollow seal portion 30 can be extruded integrally by an extruder.

When the insert member 27 is embedded in the trim portion 20, the insert member 27 is extruded together with the trim portion 20 and the like.

In the extrusion of the opening trim weather strip 10, with respect to the extruding materials, for the solid material or finely foamed material, a polyolefin-based elastomer is used as the thermoplastic elastomer. As the sponge material, the aforesaid EPDM rubber or the thermoplastic elastomer is used and is made to be foamed.

For the hard material, a polyethylene resin, polypropylene resin, hard rubber, hard thermoplastic elastomer or the like can be used.

In the case of a synthetic rubber, after extrusion, an extruded rubber is transferred to a vulcanization tank and is then heated by hot air or high-frequency wave for vulcanization and foaming. In the case of the thermoplastic elastomer and the soft synthetic resin, the resin is heated to be foamed at the same time as or after extrusion and is then cooled to be set. Thereafter, the set resin is cut into a predetermined length, whereby the extrusion of the extruded portion is completed.

The extruded opening trim weather strip 10 may be cut into a predetermined length and then connected together at ends thereof so as to be formed into an annular shape, and the annular opening trim weather strip 10 is then mounted on the flange 7 of the vehicle body opening end of a motor vehicle.

What is claimed is:

1. A weather strip for sealing a gap between an open/close member of a vehicle body opening and a peripheral part of the vehicle body opening, the weather strip comprising:
a mounting base portion adapted to be mounted on a flange provided on one of the open/close member of the vehicle body opening and the peripheral part of the vehicle body opening; and
a seal portion provided integrally on the mounting base portion so as to be brought into contact with the other of the opening open/close member and the peripheral part of the vehicle body opening so as to seal the gap between the open/close member and the peripheral part of the vehicle body opening;
wherein the mounting base portion is provided with at least a bottom wall and an exterior side wall,
a connecting portion of the exterior side wall with the bottom wall is formed more rigid than other portions of the mounting base portion and a pressure sensitive adhesive double sided tape is bonded to an interior side surface of the exterior side wall, and
a flange contact portion for locking a distal end of the flange is formed on an inner surface of the bottom wall at a position lying in a vicinity of the connecting portion of the bottom wall with the exterior side wall, and a caulking member for sealing the distal end of the flange is mounted on the inner surface of the bottom wall except for a position where the flange contact portion is formed.

2. A weather strip according to claim 1, wherein the connecting portion between the exterior side wall and the bottom wall is formed of a hard member.

3. A weather strip according to claim 2, wherein the connecting portion between the exterior side wall and the bottom wall and the other portions of the bottom wall are formed integrally of a hard member.

4. A weather strip according to claim 2, wherein the hard member is formed of a hard rubber of JIS HA85 to 95.

5. A weather strip according to claim 1, wherein an insert member is embedded in the connecting portion between the exterior side wall and the bottom wall.

6. A weather strip according to claim 1, wherein the caulking member is formed so as to get thicker toward a distal end of the bottom wall.

7. A weather strip according to claim 1, wherein a cushion layer is provided between the pressure sensitive adhesive double sided tape and the exterior side wall.

8. A weather strip according to claim 1, wherein the open/close member is a door, and the weather strip is an opening trim weather strip.

9. A weather strip according to claim 1, wherein a caulking member is provided on an inner surface of the bottom wall, an interior end portion of the bottom wall is formed more flexible than the other portions of the bottom wall, and an interior projecting portion is formed on an inner surface of the interior end portion of the bottom wall.

10. A weather strip according to claim 9, wherein the interior end portion of the bottom wall is formed of a soft material within a range from ⅕ to ⅓ of the bottom wall from an interior end thereof, and a remaining portion of the bottom wall other than the interior end portion is formed of a hard material.

11. A weather strip according to claim 9, wherein an insert member is embedded in an inner part of the exterior side wall and the remaining portion of the bottom wall other than the interior end portion.

12. A weather strip according to claim 9, wherein an interior side surface of the caulking member and an exterior side surface of the interior projecting portion of the bottom wall are secured to each other.

13. A weather strip according to claim 9, wherein an outer surface of the interior end portion of the bottom wall is brought into contact with an interior component provided on either of the open/close member and the peripheral part of the vehicle body opening, whereby the interior end portion of the bottom wall bends, and the interior projecting portion is made to incline in a direction of a side of the flange.

14. A weather strip according to claim 9, wherein a bottom wall lip is formed on the outer surface of the interior end portion of the bottom wall, and the bottom wall lip is brought into contact with an interior component provided on either of the open/close member and the peripheral part of the vehicle body opening, whereby the interior end portion of the bottom wall bends, and the interior projecting portion is made to incline in a direction of a side of the flange.

15. A weather strip according to claim 9, wherein the interior projecting portion is formed into a lip-like shape which tapers toward a distal end thereof for contact against the side of the flange.

16. A weather strip according to claim 9, wherein a stepped portion for locking a distal end of the flange is formed on the inner surface of the bottom wall at a position in the vicinity of a connecting portion of the bottom wall with the exterior side wall.

17. A weather strip according to claim 9, wherein the open/close member is a door and the weather strip is an opening trim weather strip.

18. A weather strip according to claim 9, wherein the seal portion and the caulking member of the weather strip are formed of a sponge material of an EPDM rubber or olefin-based thermoplastic elastomer, and the mounting base portion is formed of a solid material or finely foamed material of an EPDM rubber or olefin-based thermoplastic elastomer.
